(19) United States
(12) Patent Application Publication
(10) Pub. No.: US 2008/0028711 A1
(43) Pub. Date: Feb. 7, 2008

(54) CEMENT SHUTTER HANGING SYSTEM

(76) Inventors: J. Richard Logan, Oxford, MI (US); Thomas Baker, Dryden, MI (US); Andrew Leslie, Lapeer, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/834,826

(22) Filed: Aug. 7, 2007

Related U.S. Application Data
(60) Provisional application No. 60/821,597, filed on Aug. 7, 2006.

(51) Int. Cl. E04B 1/38; E04G 13/00; E06B 7/28

(52) U.S. Cl. 52/512; 248/207; 249/15

(57) ABSTRACT

A shutter assembly having a foam insert or core enveloped by a cementitious shell is provided with integrated spaced and opposed top and bottom hanger members that allow the shutter assembly to be mounted to an exterior wall of a dwelling or other structures via spaced and opposed brackets affixed to the exterior wall. The shutter assembly can be mounted to an exterior wall of a dwelling or other structure by selectively engaging the top and bottom hanger members with corresponding top and bottom bracket members mounted to the exterior wall of the dwelling or other structure.

### CROSS-REFERENCE TO RELATED APPLICATION

The instant application claims priority to U.S. Provisional Patent Application Ser. No. 60/821,597, filed Aug. 7, 2006, the entire specification of which is expressly incorporated herein by reference.

### BACKGROUND OF THE INVENTION

1. Field of the Invention

The subject invention relates to shutter assemblies and more specifically to hanging systems for shutter assemblies, especially those formed from cementitious slurries.

2. Description of the Related Art

Many different modern building designs take advantage of modular shutters for purely aesthetic purposes to decorate exterior windows. The modular shutter assemblies are generally an assembly of plastic parts that are individually formed and then secured together in a cost effective manner. The different plastic parts can be formed by different plastic fabrication techniques such as injection molding and extrusion. The plastic parts are secured together by appropriate fastening mechanisms, such as screws, adhesives, and/or the like, in a manner that is well understood in the art.

Because the shutters are employed for purely aesthetic purposes, it is important to choose an appropriate shutter style that complements, rather than detracts from, the exterior wall surface of the building onto which it is to be mounted. In this respect, certain buildings, especially upscale residential and commercial buildings having stucco, stone, and/or brick exterior walls, are generally not enhanced by the use of plastic, or even metallic, shutters, regardless of the quality and/or cost thereof. That is, the use of a plastic or metallic shutter does not, from an aesthetic viewpoint, coordinate very well with a building having stucco, stone, and/or brick exterior walls.

Additionally, it has been problematic to install shutter assemblies to the building's exterior walls without having to drill large and deep holes therein to accommodate screws that hold the shutter assemblies securely in place. These holes provide ingress for water, dirt, insects, and/or the like that could damage the wall or other surrounding structures. Toward this end, certain municipalities have enacted regulations on if, and how, holes can or cannot be provided in exterior walls for any purpose, including the hanging of shutter assemblies.

Recently, the use of shutter assemblies formed from cementitious slurries, including those with a foam core, has been suggested for use with buildings having stucco, stone, and/or brick exterior walls. However, securely hanging these types of shutter assemblies onto exterior walls, especially those formed from stucco, stone, and/or brick, has been problematic.

Therefore, it would be advantageous to provide new and improved hanging systems for shutter assemblies, such as but not limited to those formed from cementitious slurries, including those with a foam core, that overcome at least one of the aforementioned problems.

### SUMMARY OF THE INVENTION AND ADVANTAGES

The subject invention provides a hanging system for a shutter assembly, including those having a foam core enveloped by a cement or cementitious exterior shell. The cementitious shell can also be provided with a first hanger member that allows the top portion of the shutter assembly to be mounted to a dwelling, e.g., via a bracket affixed to an exterior wall surface thereof. The cementitious shell can also be provided with a second hanger member that allows the bottom portion of the shutter assembly to be mounted to a dwelling, e.g., via a bracket affixed to an exterior wall surface thereof, wherein a free end of a tie member secured by the bracket extends around a bar member fixed in a cavity formed in the cementitious shell. The free end of the tie member is then threaded through a securing member and drawn taut around the bar member, thus drawing the shutter assembly tightly against the dwelling. Any excess portion of the free end of the tie member can be trimmed so as to not be seen extending from the bottom of the shutter assembly. In this manner, the shutter assembly is securedly fastened to the dwelling and will not be easily dislodged therefrom, e.g., in case of high winds, storms, hurricanes, tornados, and/or the like. To remove the shutter assembly, a portion, e.g., the securing member, of the tie member is cut, e.g., by snips, scissors, and/or any other cutting tool, thus releasing the tie member from the bar member whereupon the shutter assembly can be lifted up and/or off of the first hanger member and removed from the exterior wall of the dwelling.

The shutter assembly is formed in a closed mold from a cementitious slurry comprising gypsum cement (e.g., white or grey Portland cement) and water. The slurry can also contain other materials such as but not limited to reinforcement materials (e.g., fibers), as well as other materials that are known in the art (e.g., plasticizers and/or the like). An appropriate amount of the cementitious slurry is added onto a bottom mold surface portion to a desired depth. The respective hanger members are placed onto the bottom mold surface portion, e.g., prior to the introduction of the cementitious slurry. The foam core is then placed atop the cementitious slurry in a desired orientation, the mold is vibrated and pressure is applied to close the mold to a predetermined thickness, such that the top mold surface portion is brought into contact with the bottom mold surface portion. After an appropriate curing or drying time, the shutter assembly is removed from the mold and is ready for immediate use and/or further processing, such as but not limited to painting and/or the like.

In accordance with one embodiment of the present invention, a method for forming a molded component, such as a shutter, is provided, comprising providing a mold surface member, charging an amount of a cementitious material onto the mold surface member, and providing a hanger member that is at least partially enveloped by the cementitious material.

The hanger member can include a body portion having an inner surface and an outer surface, wherein the body portion includes at least one angled portion formed therein. The outer surface is substantially submerged within the cementitious material, whereas the inner surface is substantially free of cementitious material. The outer surface includes at least one fin member formed thereon. The inner surface includes an area defining a recess. The recess is selectively operable to receive a mounting member therein.

A second hanger member can also be provided, wherein the second hanger member includes a body portion having an inner surface and an outer surface. The body portion includes at least one angled portion formed therein, wherein the second hanger member is spaced and opposed from the hanger member. The outer surface of the second hanger member is substantially submerged within the cementitious material, whereas the inner surface of the second hanger member is substantially free of cementitious material. The outer surface of the second hanger member includes at least one fin member formed thereon. The inner surface of the second hanger member includes an area defining a recess. A bar member traverses across the recess of the second hanger member. The recess of the second hanger member is selectively operable to receive a mounting member therein, wherein the mounting member is selectively operable to extend around at least a portion of the bar member.

A foam member can be disposed into the cementitious material such that the foam member is at least partially enveloped by the cementitious material.

In accordance with another embodiment of the present invention, a molded component, such as a shutter, is provided, comprising a hanger member, and a cementitious shell at least partially enveloping the hanger member. The hanger member includes a body portion having an inner surface and an outer surface, wherein the body portion includes at least one angled portion formed therein. The outer surface is substantially submerged within the cementitious material, whereas the inner surface is substantially free of cementitious material. The outer surface includes at least one fin member formed thereon. The inner surface includes an area defining a recess, wherein the recess is selectively operable to receive a mounting member therein.

A second hanger member can also be provided, wherein the second hanger member includes a body portion having an inner surface and an outer surface, wherein the body portion includes at least one angled portion formed therein. The second hanger member is spaced and opposed from the hanger member. The outer surface of the second hanger member is substantially submerged within the cementitious material. The inner surface of the second hanger member is substantially free of cementitious material. The outer surface of the second hanger member includes at least one fin member formed thereon. The inner surface of the second hanger member includes an area defining a recess. A bar member traverses across the recess of the second hanger member, wherein the recess of the second hanger member is selectively operable to receive a mounting member therein, wherein the mounting member is selectively operable to extend around at least a portion of the bar member.

A foam member can be disposed into the cementitious material such that the foam member is at least partially enveloped by the cementitious material.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a front elevational view of a dwelling having a plurality of shutter assemblies mounted thereto, in accordance with a first embodiment of the present invention;

FIG. 2 is a front elevational view of a louvered shutter, in accordance with a second embodiment of the present invention;

FIG. 3 is a front elevational view of a plain panel shutter, in accordance with a third embodiment of the present invention;

FIG. 4 is a front elevational view of a batten shutter, in accordance with a fourth embodiment of the present invention;

FIG. 5 is a perspective view of a batten shutter, in accordance with a fifth embodiment of the present invention;

FIG. 6 is a partial sectional view taken along line 6-6 of FIG. 5, in accordance with a sixth embodiment of the present invention;

FIG. 7 is a sectional view taken along line 7-7 of FIG. 5, in accordance with a seventh embodiment of the present invention;

FIG. 8 is an exploded view of a molding system for forming a shutter assembly, in accordance with an eighth embodiment of the present invention;

FIG. 9 is a perspective view of a bottom molding member on a conveyor system, in accordance with a ninth embodiment of the present invention;

FIG. 10 is an exploded view of a mold surface member and the bottom molding member on the conveyor system depicted in FIG. 9, in accordance with a tenth embodiment of the present invention;

FIG. 11 is a perspective view of the mold surface member and the bottom molding member on the conveyor system depicted in FIG. 10, in accordance with an eleventh embodiment of the present invention;

FIG. 12 is a perspective view of a cementitious slurry being added onto the mold surface member depicted in FIG. 11, in accordance with a twelfth embodiment of the present invention;

FIG. 13 is a perspective view of the cementitious slurry having been added to a desired depth onto the mold surface member depicted in FIG. 12, in accordance with a thirteenth embodiment of the present invention;

FIG. 14 is a perspective view of a foam insert and a top hanger member and a bottom hanger member being placed onto the cementitious slurry depicted in FIG. 13, in accordance with a fourteenth embodiment of the present invention;

FIG. 14a is a perspective view of the top hanger member, in accordance with a fifteenth embodiment of the present invention;

FIG. 14b is a perspective view of the bottom hanger member, in accordance with a sixteenth embodiment of the present invention;

FIG. 15 is a perspective view of the foam insert and top and bottom hanger members depicted in FIG. 14 being substantially enveloped by the cementitious slurry, in accordance with a seventeenth embodiment of the present invention;

FIG. 16 is a perspective view of the upper mold member being brought into contact with the lower mold member depicted in FIG. 15, in accordance with an eighteenth embodiment of the present invention;

FIG. 17 is an exploded view of the mold surface member being removed from the lower mold member depicted in FIG. 16, in accordance with a nineteenth embodiment of the present invention;

FIG. 18 is an exploded view of the shutter assembly being removed from the mold surface member depicted in FIG. 17, in accordance with a twentieth embodiment of the present invention;

FIG. 19 is a partial perspective view of a top bracket system and a bottom bracket system attached to an exterior wall of a dwelling, in accordance with a twenty-first embodiment of the present invention;

FIG. 20 is a partial sectional view of a shutter assembly being mounted to the top bracket system depicted in FIG. 19, in accordance with a twenty-second embodiment of the present invention;

FIG. 21 is a partial sectional view of a shutter assembly being mounted to the bottom bracket system depicted in FIG. 19, in accordance with a twenty-third embodiment of the present invention; and

FIG. 22 is a bottom view of a mounted shutter assembly, in accordance with a twenty-fourth embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

Referring to the Figures, wherein like numerals indicate like or corresponding parts throughout the several views, a shutter assembly is generally disclosed at 10. By “assembly,” as that term is used herein, it is meant at least one shutter member.

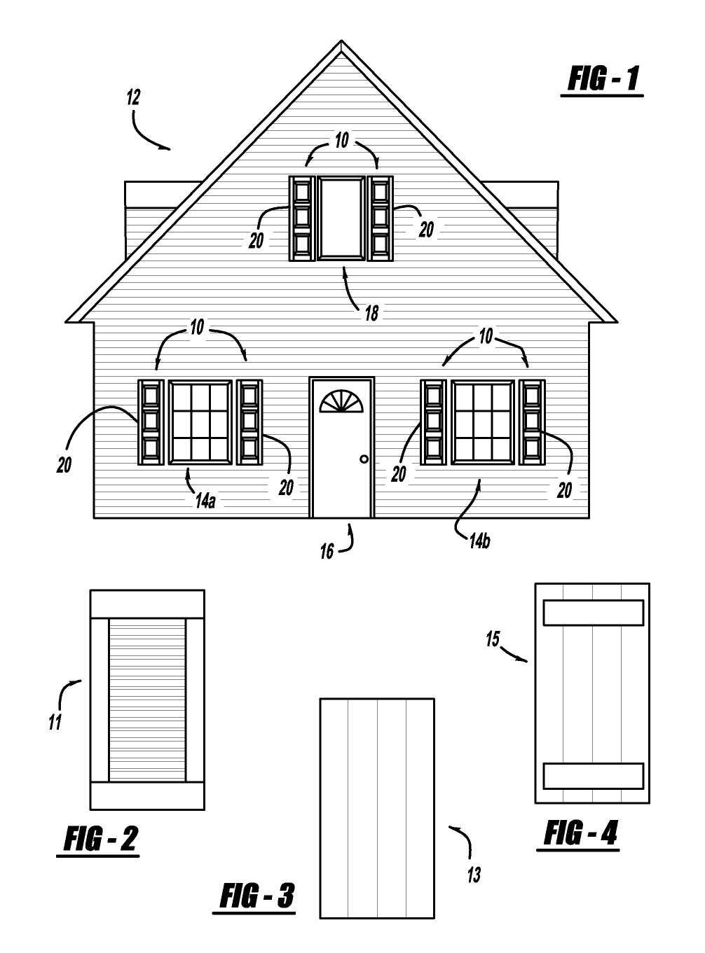

The shutter assembly 10 can be mounted, either permanently or temporarily to a dwelling 12, such as a residential or commercial building, especially one that includes a stucco, stone and/or brick exterior. FIG. 1 shows an exterior front view of a house 12 that includes two lower story front windows 14a, 14b, respectively, positioned on opposite sides of a door 16 and an upper story front window 18. Positioned on both sides of each of the windows 14a, 14b, 18, respectively, is a shutter assembly 10. The shutter assemblies 10 are rigidly secured to a front wall of the house 12 by appropriate securing devices, to be described herein, at a location that aesthetically accents the windows 14a, 14b, 18, respectively.

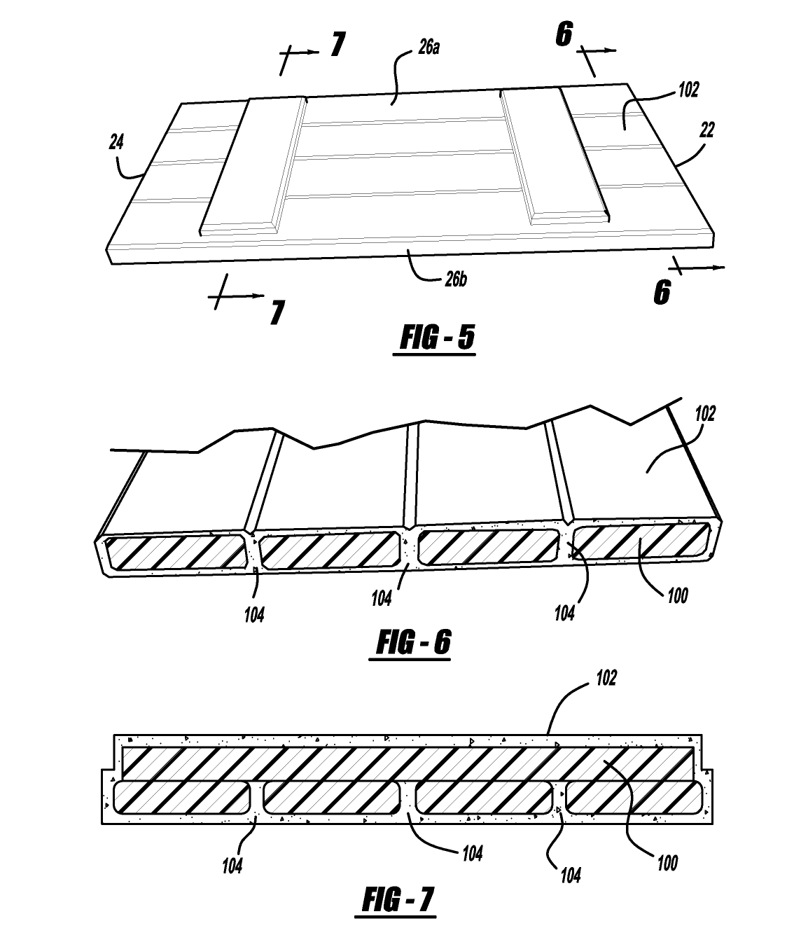

Although raised/recessed panel shutter members are shown in connection with the shutter assemblies 10 in FIG. 1, it should be appreciated that various other configurations of the shutter assembly 10 can be employed with the practice of the present invention. With specific reference to FIGS. 2-4, the shutter assemblies 10 of the present invention can include, without limitation, a louvered shutter member 11, a flat panel shutter member 13, a batten shutter member 15, and/or the like.

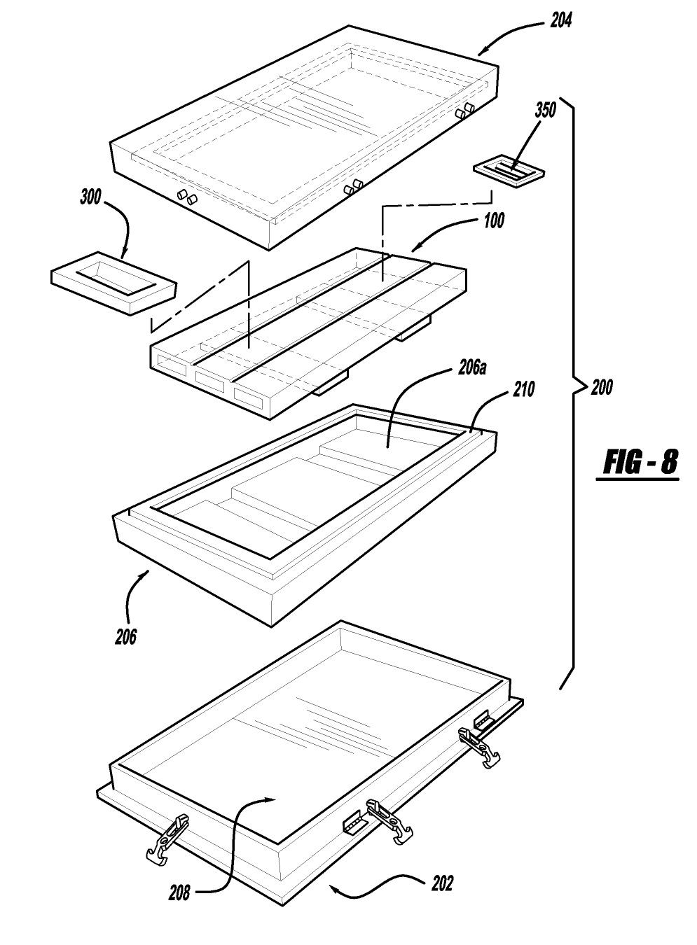

It is to be understood that one shutter assembly 10 according to the subject invention is a single shutter 20. That is, one shutter assembly 10 is one left side shutter 20 or one right side shutter 20 such that two shutter assemblies 10 are preferred. For example, with specific reference to FIGS. 5-7, each shutter assembly 10 has a top 22, a bottom 24 and two sides 26a, 26b, respectively, extending between the top 22 and bottom 24.

The shutter assembly 10 includes a foam insert or core 100 that is completely or at least substantially completely enveloped or surrounded by a cementitious shell or coating 102. Various portions of the cementitious shell 102 can be permitted to infiltrate through various crevices, apertures, or spaces formed in the foam core 100, e.g., so as to form reinforcement or rib members 104 at various locations within the shutter assembly 10.

In accordance with one aspect of the present invention, the cementitious shell 102 is formed from a cementitious or cement slurry. The slurry can include hydraulic cement including, but not limited to, Portland, sorrel, slag, fly ash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement. The cementitious slurry preferably includes gypsum cement and a sufficient amount of water added thereto to produce a slurry having the desired consistency, i.e., not too dry nor not too watery.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaSO₄.½H₂O. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and retarders to control setting times of slurry. Suitable accelerators include aluminum sulfate, potassium sulfate, and Terra Alba ground gypsum. Additional additives can be used to produce colored shutter assemblies 10, such dry powder metallic oxides such as iron and chrome oxide and pre-dispersed pigments used for coloring latex paints.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR® from DuPont of Wilmington, Del. Of course, aromatic polyamide fibers other than KEVLAR® are suitable for use in the fiber composition of the subject invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

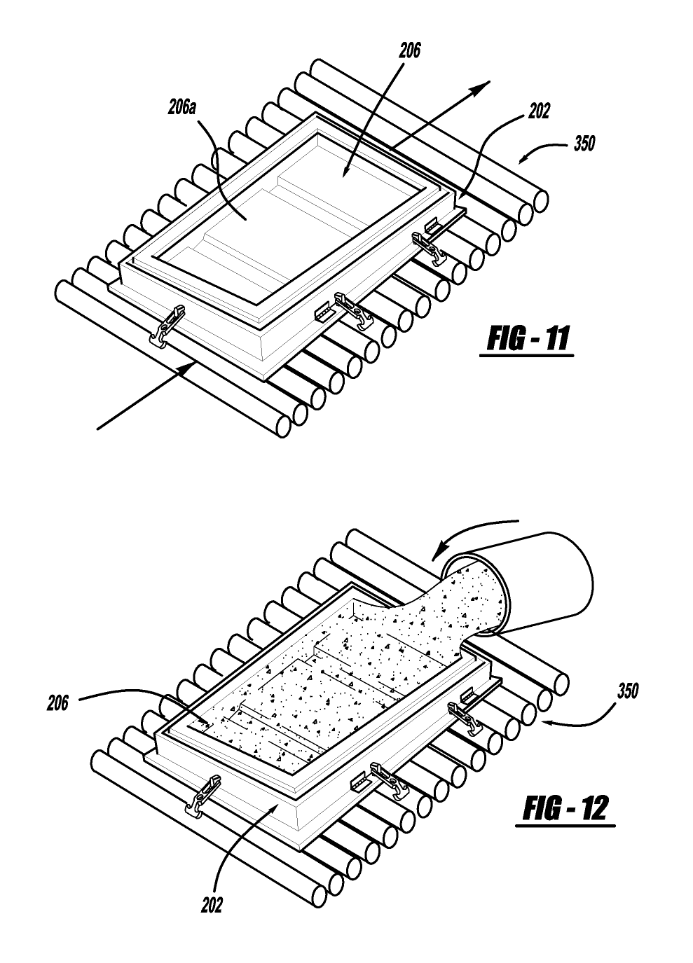

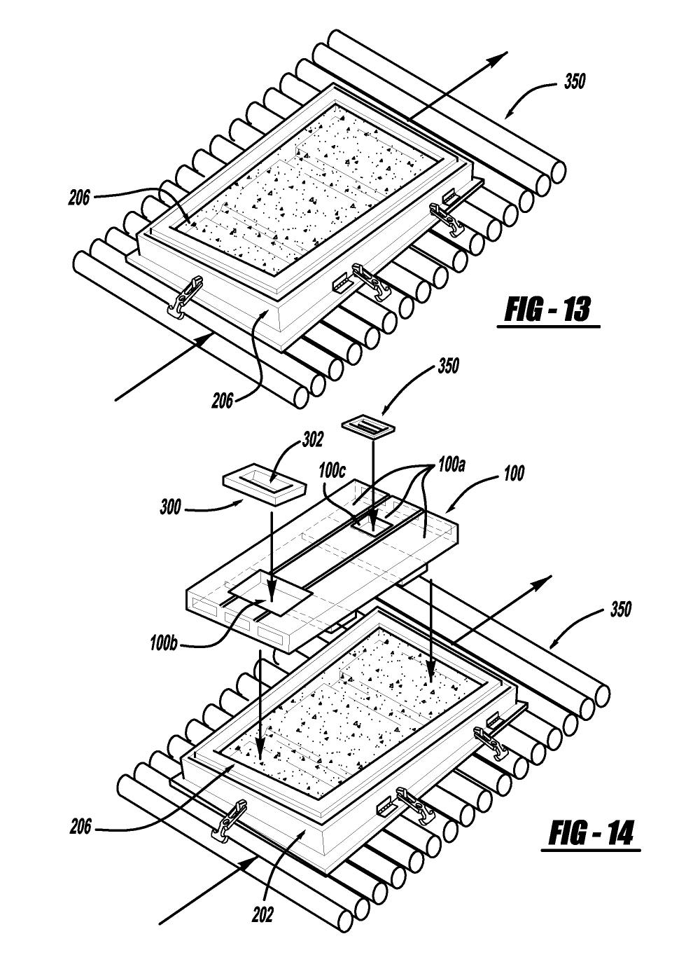

Referring to FIGS. 8-18, one illustrative system and method of forming the shutter assembly 10 of the present invention is shown as being formed in a selectively closable mold system 200. With specific reference to FIG. 8, the mold system 200 includes a lower or bottom mold surface portion 202 and an upper or top mold surface portion 204 that are selectively operable to come into and out of contact with one another. By way of a non-limiting example, the upper or top mold surface portion 204 can be hingedly attached to the lower or bottom mold surface portion 202, such that the upper or top mold surface portion 204 can rotate downwardly towards or upwardly away from the lower or bottom mold surface portion 202. Additionally, the mold system 200, and components thereof, can be operated either manually and/or automatically.

A mold surface member 206 is preferably disposed within a cavity 208 formed in the lower or bottom mold surface portion 202. Although the lower or bottom mold surface portion 202 is shown as being an open shell having a substantially rectangular configuration, the lower or bottom mold surface portion 202 can have any number of various configurations. The mold surface member 206 can be formed of any type of material, such as rigid or flexible materials; however, preferably the mold surface member 206 is formed from a suitably flexible material that, e.g., can be removed from the cavity 208. The face 206a of the mold surface member 206 is essentially a negative image of the desired front exterior surface shape of the shutter assembly 10. Additionally, the mold surface member 206 preferably includes a peripheral lip member 210 to aid in grasping the mold surface member 206, e.g., when it is desired to remove the mold surface member 206 from the cavity 208. The foam core or insert 100 and an optional hanger member 300 are shown for illustrative orientation purposes.

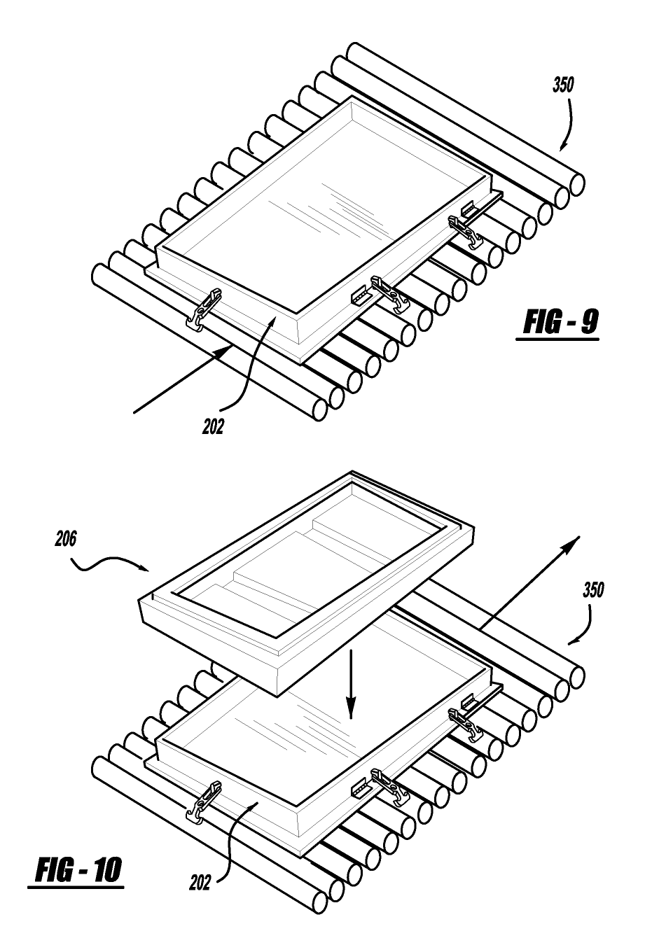

Because of the weights involved of the various components, as well as the cementitious slurry, a transport device, such as a conveyor system 350 (e.g., see FIG. 9), either manually or automatically operated, can be employed to guide the mold system 200 along during the manufacturing process, e.g., from an initial processing station, to a curing station, and finally to a product removal station. In this manner, many shutter assemblies can be produced sequentially and rapidly (e.g., in an assembly line process) without having to wait for each individual shutter assembly to be finally and completely manufactured.

After the cementitious slurry has been prepared, as described above, the cementitious slurry, preferably when still wet, is then poured into the bottom mold surface portion 202, either manually or mechanically, such that it contacts and fills the mold surface member 206 to a desired depth (e.g., see FIGS. 10-13). By way of a non-limiting example, the cementitious slurry is poured onto the mold surface member 206 until it reaches a depth of about one-half way up the exterior wall of the mold surface member 206. However, it should be appreciated that either less than or more than this amount of the cementitious slurry can be used, e.g., depending on the specific application.

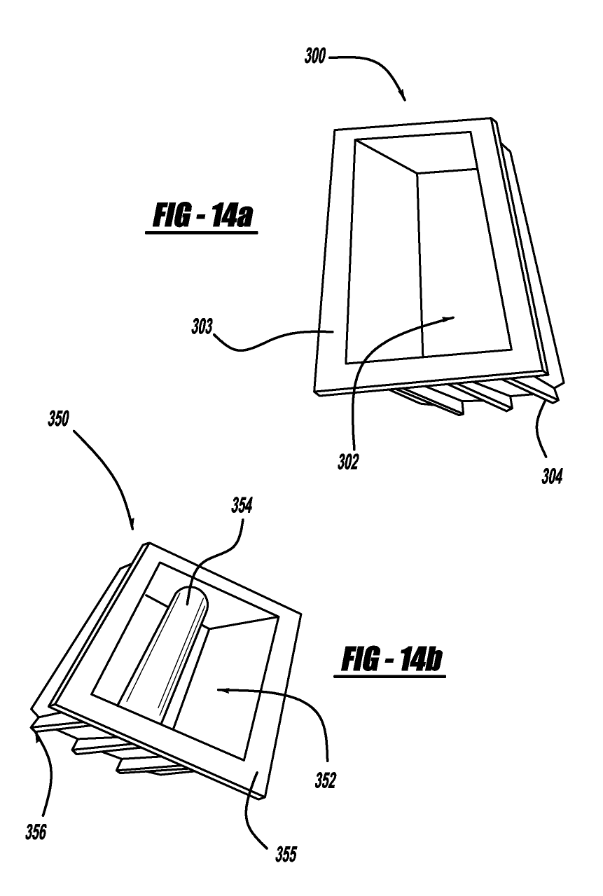

With specific reference to FIGS. 14, 14a, 14b, and 15, it should be noted that a top hanger member 300 and a bottom hanger member 350 can be placed, in a proper orientation, on the mold surface member 206 prior to the introduction of any cementitious slurry therein. However, it should be appreciated that the top hanger member 300 and bottom hanger member 350 can also be placed on the mold surface member 206 after the introduction of any cementitious slurry therein.

The top hanger member 300 can be used for mounting a top portion of the shutter assembly 10 to the dwelling 12 instead of driving fasteners through the shutter assembly 10. The top hanger member 300 includes an area defining a recess 302 that is operable to receive a bracket (to be described herein) or other mounting device mounted to the dwelling 12, thus obviating the need to drive fasteners through the shutter assembly 10, which could potentially damage the cementitious material, e.g., via cracking and/or the like. The recess 302, or a portion thereof, can be angled with respect to the other portions of the top hanger member 300. The angled configuration can provide better anchoring of the top hanger member 300 in the cementitious slurry, especially after curing. Additionally, the top hanger member 300 can be designed to be disposed in a cutout portion 100b formed in the foam core or insert 100 itself, or alternatively, the foam core or insert 100 can be designed to only extend up to, but not past or above the level of the top hanger member 300. An optional face plate 303 can be provided around the periphery to prevent any cementitious slurry from flowing into the recess 302. Furthermore, optional fin or blade members 304 can be provided on an exterior surface of the top hanger member 300 to better mate with the surrounding cementitious slurry, especially after curing.

The bottom hanger member 350 can be used for mounting a bottom portion of the shutter assembly 10 to the dwelling 12 instead of driving fasteners through the shutter assembly 10. In this manner, both the top hanger member 300 and the bottom hanger member 350 can securely fasten the shutter assembly 10 to the dwelling 12, instead of relying on a single hanger member. The bottom hanger member 350 includes an area defining a recess 352 that includes a bar member 354 extending there across. The recess 352, or a portion thereof, can be angled with respect to the other portions of the bottom hanger member 350. The angled configuration can provide better anchoring of the bottom hanger member 350 in the cementitious slurry, especially after curing. The recess 352 is operable to receive a fastening member (to be described herein) or other mounting device mounted to the dwelling 12, thus obviating the need to drive fasteners through the shutter assembly 10, which could potentially damage the cementitious material, e.g., via cracking and/or the like. Additionally, the bottom hanger member 350 can be designed to be disposed in a second cutout portion 100c formed in the foam core or insert 100 itself, or alternatively, the foam core or insert 100 can be designed to only extend up to, but not past or above the level of the bottom hanger member 350. An optional face plate 355 can be provided around the periphery to prevent any cementitious slurry from flowing into the recess 302. Furthermore, optional fin or blade members 356 can be provided on an exterior surface of the bottom hanger member 350 to better mate with the surrounding cementitious slurry, especially after curing.

As noted, once a sufficient amount of the cementitious slurry is disposed onto the mold surface member 206, the foam core or insert 100 is then placed onto the cementitious slurry and is properly positioned in the mold in a desired orientation. The cementitious slurry initially penetrates through any crevices, apertures or spaces between adjacent portions of the foam core or insert 100, such as the crevices, apertures or spaces formed between the individual slat members 100a and in this manner forms the reinforcement or rib members 104 previously described. Optionally, a vibratory force can be applied to the mold system 200, e.g., to remove any residual air bubbles in the cementitious slurry, e.g., either before or after the foam core or insert 100 is placed therein.

It should be noted that the exact sequencing of the positioning onto the mold surface 206 of either of the top hanger member, bottom hanger member 350 and/or the foam core or insert 100 is not thought to be critical to the success of the present invention. That is, for example, the foam core or insert 100 can be positioned first, the bottom hanger member 350 positioned second, and the top hanger member 300 positioned last, or any combination of these individual steps. Additionally, any of these positioning steps can take place prior to and/or after the pouring of the cementitious slurry onto the mold surface 206.

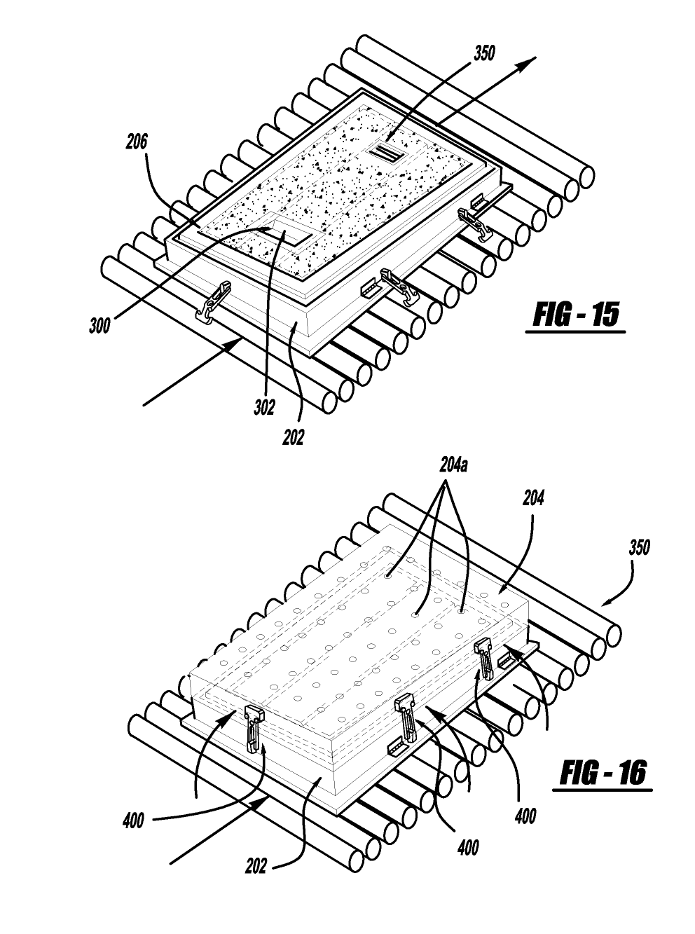

With specific reference to FIG. 16, because the foam core or insert 100 can have a tendency to float, the upper or top mold surface portion 204 is brought into contact with the lower or bottom mold surface portion 202 so as to keep the foam core or insert 100 at least partially and preferably completely submerged within the cementitious slurry. The upper or top mold surface portion 204 can be provided with a series of members 204a, e.g., bumps, which project outwardly from the face of the upper or top mold surface portion 204 such that they contact, either constantly or intermittently, the foam core or insert 100 and keep the same from excessively floating upwardly out of the cementitious slurry.

In accordance with one aspect of the present invention, the upper or top mold surface portion 204 can be secured to the lower or bottom mold surface portion 202 with fastening devices 400 so as to prevent the upper or top mold surface portion 204 and the lower or bottom mold surface portion 202 from becoming inadvertently dislodged from one another. The cementitious slurry is then allowed to dry, harden or cure for a sufficient amount of time, which may depend, at least in part, on the specific composition of the cementitious slurry used. The mold system 200 can also be shuttled off of the conveyor system 350 and stored in a storage area (not shown) so that other shutter assemblies can be made in the interim.

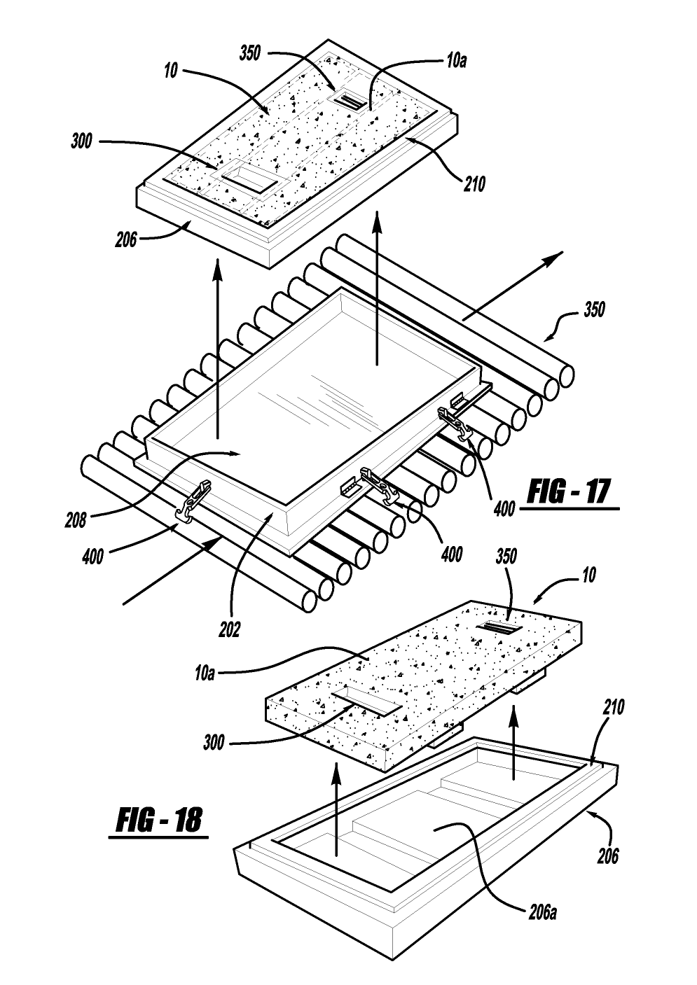

With specific reference to FIGS. 17 and 18, once the cementitious slurry has dried, hardened or cured, the shutter assembly 10 can then be removed from the mold system 200. By way of a non-limiting example, the fastening devices 400, if used, are disengaged so as to enable the upper or top mold surface portion 204 to be removed from the lower or bottom mold surface portion 202, thus exposing the rear face 10a of the shutter assembly 10. The mold surface member 206 can then be removed from the cavity 208 by grapping the peripheral lip member 210 and lifting the mold surface member 206 upwardly and out of the cavity 208. The mold surface member 206 is then removed from the shutter assembly 10, thus exposing the finished product, which is preferably allowed to dry to a suitable extent, after which time it can then be used immediately or further processed, e.g., painted or otherwise treated.

An illustrative example of mounting the shutter assembly 10 to a surface (e.g., an exterior wall, an interior wall, and/or the like) of a dwelling 12, or other structures, will now be described.

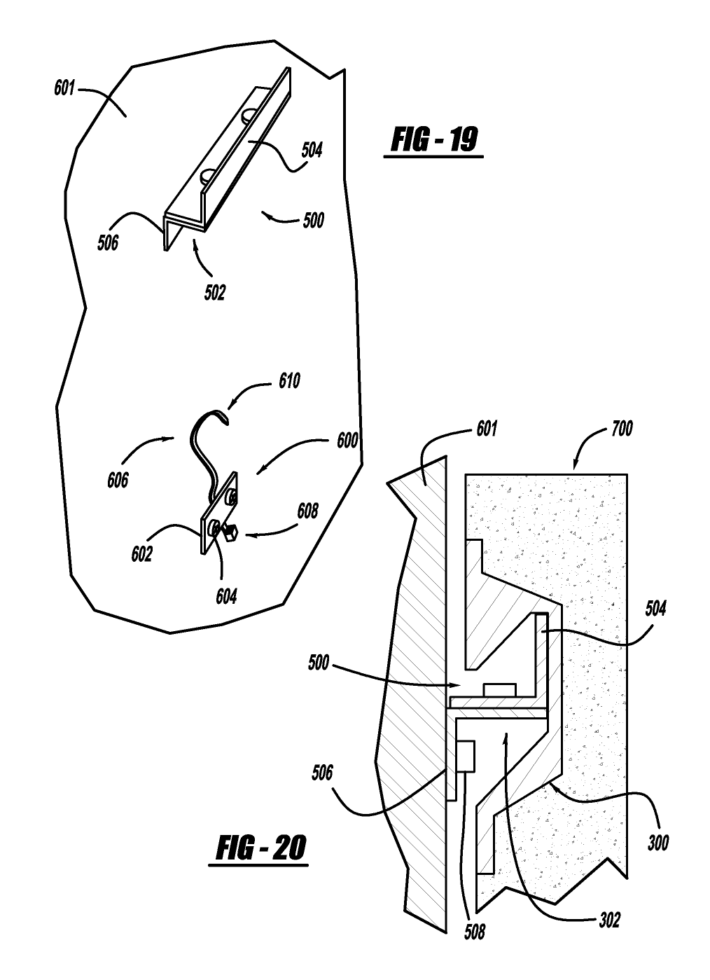

With reference to FIG. 19, there is shown a perspective view of a top bracket system 500 and a bottom bracket system 600 attached to an exterior wall 601 of a dwelling, in accordance with a twenty-first embodiment of the present invention. The top bracket system 500 includes a bracket member 502 that includes a bracket surface 504 (e.g., a substantially L-shaped member) and a mounting surface 506. Fastening members 508 (e.g., screws, bolts and/or the like) are used to mount the mounting surface 506 (e.g., through appropriately spaced apertures formed in the mounting surface 506) to the exterior wall 601 of the dwelling. The bottom bracket system 600 includes a bracket member 602. Fastening members 604 (e.g., screws, bolts and/or the like) are used to mount the bracket member 602 (e.g., through appropriately spaced apertures formed in the bracket member 602) to the exterior wall 601 of the dwelling. However, a tie member 606 is placed between the exterior wall 601 and the bracket member 602 such that the tie member 606 is held tightly against the exterior wall 601 by the bracket member 602. The tie member 606 is positioned such that a securing portion 608 is adjacent to or abuts an edge surface (e.g., a bottom edge) of the bracket member 602 and a free end 610 of the tie member 606 extends upwardly past an edge surface (e.g., a top edge) of the bracket member 602.

Referring to FIG. 20, there is shown a partial sectional view of a shutter assembly 700 being mounted to the top bracket system 500 depicted in FIG. 19, in accordance with a twenty-second embodiment of the present invention. In this view, the shutter assembly 700 is positioned such that the bracket surface 504 is received within the recess 302 formed in the top hanger member 300, as previously described. The bracket surface 504 then merely rests upon the upper portion of the recess 302 of the top hanger member 300.

Referring to FIG. 21 is a partial sectional view of the shutter assembly 700 being mounted to the bottom bracket system 600 depicted in FIG. 19, in accordance with a twenty-third embodiment of the present invention. In this view, the shutter assembly 700 is positioned such that the free end 610 of the tie member 606 is able to be looped around the bar member bracket 354 disposed in the recess 352 of the bottom hanger member 350. Once this is done, the free end 610 of the tie member 606 is then threaded through the securing portion 608 and drawn therethrough such that the shutter assembly 700 is drawn tight against the bottom bracket system 600 and thus against the exterior wall 601. The securing portion 608 can be configured so as to prevent the free end 610 of the tie member 606 from slipping back out of the securing portion 608 once is it is inserted therethrough (e.g., through a modified “pawl and ratchet” system used in conventional plastic zip ties, cable ties and/or the like).

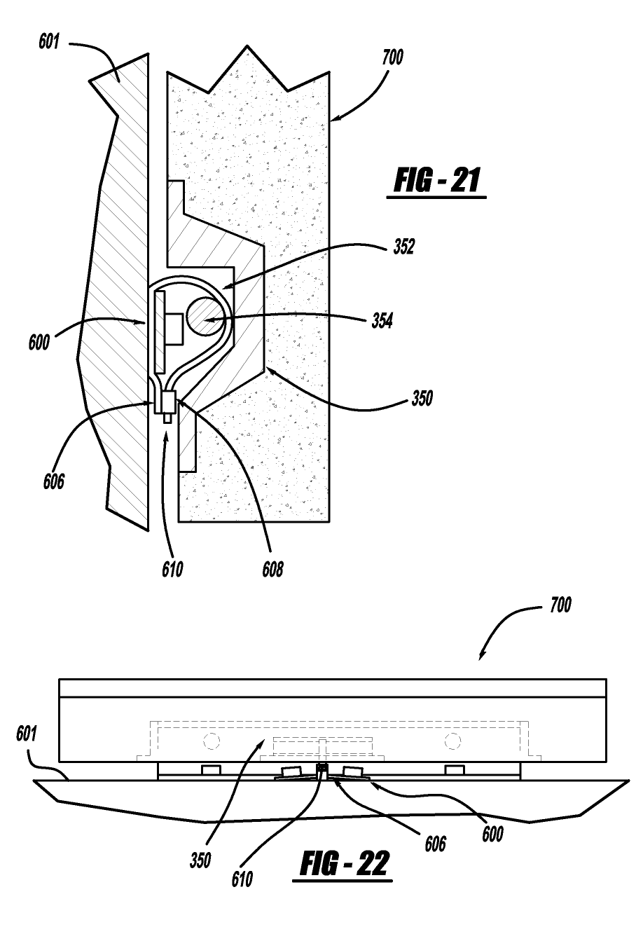

Referring to FIG. 22, there is shown a bottom view of the mounted shutter assembly 700, in accordance with a twenty-fourth embodiment of the present invention. In this view, the excess portion of the free end 610 of the tie member 606 has been removed (e.g., with snips, scissors, clippers, and/or the like) such that it is hard to detect the presence of the bottom bracket member 350 and/or the bottom bracket system 600. The free end 610 is preferably removed such that only a very small portion of the free end 610 can be seen extending from the securing portion 608. Alternatively, the free end 610 is preferably removed such that none of the free end 610 can be seen extending from the securing portion 608, i.e., only the securing portion 608 is visible. Additionally, because of the configuration of the mounted shutter assembly 700, even the securing portion 608 itself would be very difficult to be seen, thus not detracting from the aesthetic value of the shutter assembly 700. Accordingly, a person viewing the mounted shutter assembly 700 would be unable to instantly discern how the shutter assembly 700 has been mounted to the exterior wall 601 of a dwelling due, in part, to the concealed nature of the mounting system of the present invention.

Additionally, once the hanger members are suitably secured to the building, e.g., as described above, the peripheral areas of the hanger members can be caulked or otherwise sealed in order to prevent the intrusion of water, and/or other undesirable elements, into the building.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming a molded component, comprising:
providing a mold surface member;
charging an amount of a cementitious material onto the mold surface member; and
providing a hanger member that is at least partially enveloped by the cementitious material.

2. The invention according to claim 1, wherein the hanger member includes a body portion having an inner surface and an outer surface.

3. The invention according to claim 2, wherein the body portion includes at least one angled portion formed therein.

4. The invention according to claim 2, wherein the outer surface is substantially submerged within the cementitious material.

5. The invention according to claim 2, wherein the inner surface is substantially free of cementitious material.

6. The invention according to claim 2, wherein the outer surface includes at least one fin member formed thereon.

7. The invention according to claim 2, wherein the inner surface includes an area defining a recess.

8. The invention according to claim 7, wherein the recess is selectively operable to receive a mounting member therein.

9. The invention according to claim 1, further comprising providing a second hanger member including a body portion having an inner surface and an outer surface.

10. The invention according to claim 9, wherein the body portion includes at least one angled portion formed therein.

11. The invention according to claim 9, wherein the second hanger member is spaced and opposed from the hanger member.

12. The invention according to claim 9, wherein the outer surface of the second hanger member is substantially submerged within the cementitious material.

13. The invention according to claim 9, wherein the inner surface of the second hanger member is substantially free of cementitious material.

14. The invention according to claim 9, wherein the outer surface of the second hanger member includes at least one fin member formed thereon.

15. The invention according to claim 9, wherein the inner surface of the second hanger member includes an area defining a recess.

16. The invention according to claim 15, further comprising providing a bar member traversing across the recess of the second hanger member.

17. The invention according to claim 16, wherein the recess of the second hanger member is selectively operable to receive a mounting member therein, wherein the mounting member is selectively operable to extend around at least a portion of the bar member.

18. The invention according to claim 1, further comprising disposing a foam member into the cementitious material such that the foam member is at least partially enveloped by the cementitious material.

19. The invention according to claim 1, wherein the component comprises a shutter.

20. A molded component, comprising:
a hanger member; and
a cementitious shell at least partially enveloping the hanger member.

21. The invention according to claim 20, wherein the hanger member includes a body portion having an inner surface and an outer surface.

22. The invention according to claim 21, wherein the body portion includes at least one angled portion formed therein.

23. The invention according to claim 21, wherein the outer surface is substantially submerged within the cementitious material.

24. The invention according to claim 21, wherein the inner surface is substantially free of cementitious material.

25. The invention according to claim 21, wherein the outer surface includes at least one fin member formed thereon.

26. The invention according to claim 21, wherein the inner surface includes an area defining a recess.

27. The invention according to claim 26, wherein the recess is selectively operable to receive a mounting member therein.

28. The invention according to claim 20, further comprising a second hanger member including a body portion having an inner surface and an outer surface.

29. The invention according to claim 28, wherein the body portion includes at least one angled portion formed therein.

30. The invention according to claim 28, wherein the second hanger member is spaced and opposed from the hanger member.

31. The invention according to claim 28, wherein the outer surface of the second hanger member is substantially submerged within the cementitious material.

32. The invention according to claim 28, wherein the inner surface of the second hanger member is substantially free of cementitious material.

33. The invention according to claim 28, wherein the outer surface of the second hanger member includes at least one fin member formed thereon.

34. The invention according to claim 28, wherein the inner surface of the second hanger member includes an area defining a recess.

35. The invention according to claim 34, further comprising a bar member traversing across the recess of the second hanger member.

36. The invention according to claim 35, wherein the recess of the second hanger member is selectively operable to receive a mounting member therein, wherein the mounting member is selectively operable to extend around at least a portion of the bar member.

37. The invention according to claim 20, further comprising a foam member disposed into the cementitious material such that the foam member is at least partially enveloped by the cementitious material.

38. The invention according to claim 20, wherein the component comprises a shutter.
